(19) United States
(12) Patent Application Publication
(10) Pub. No.: US 2023/0025077 A1
(43) Pub. Date: Jan. 26, 2023

(54) SIMULATED ROCK MODULAR FENCE APPARATUS AND SYSTEM

(71) Applicant: Smart Rock Fencing, LLC, Centerville, UT (US)

(72) Inventors: Ted W. Nelson, Salt Lake City, UT (US); David J. Black, Salt Lake City, UT (US)

(21) Appl. No.: 17/956,352

(22) Filed: Sep. 29, 2022

Related U.S. Application Data
(63) Continuation of application No. 16/362,635, filed on Mar. 23, 2019, now abandoned.
(60) Provisional application No. 62/647,171, filed on Mar. 23, 2018.

(51) Int. Cl. E04H 17/16; E02D 17/20; E04H 17/20

(52) U.S. Cl. CPC E04H 17/165; E02D 17/20; E04H 17/20

(57) ABSTRACT

A modular system of fencing components that can simulate the appearance and texture of traditional fencing materials is provided having novel connection and support components and systems to accommodate for thermal expansion while remaining strong, lightweight, easy to install and repair, and cost effective.

### CROSS-REFERENCES TO RELATED APPLICATIONS

This application is a continuation of and claims priority to U.S. patent application Ser. No. 16/362,635 entitled “SIMULATED ROCK MODULAR FENCE APPARATUS AND SYSTEM” and filed on Mar. 23, 2019, for Ted W. Nelson et al., which is incorporated herein by reference, which claims the benefit of and claims priority to U.S. Provisional Patent Application No. 62/647,171 entitled “SIMULATED ROCK MODULAR FENCE APPARATUS AND SYSTEM” and filed on Mar. 23, 2018 for Ted W. Nelson et al., the complete disclosure of which, in its entirety, is herein incorporated by reference for all purposes.

### FIELD OF THE INVENTION

The present invention relates to modular fencing components. More specifically, the present invention relates to rotationally molded modular fencing structures for simulating the appearance and texture of stone or other traditional fencing materials.

### BACKGROUND

Fencing structures may be constructed from wood, concrete, vinyl or other polymeric materials, chain link, brick and mortar, or stone. These fences may be used to surround both commercial and residential properties, and, for aesthetic and structural reasons, fencing materials like stone may be preferred.

### SUMMARY OF THE INVENTION

The present invention extends to improved modular fencing components and a modular fencing system designed to simulate the appearance and texture of traditional fencing materials, such as stone. It has been recognized that it would be advantageous to develop a fence constructed from pre-constructed modular components that can simulate the appearance and texture of stone or other traditional fencing material. Additionally, it has been recognized that it would be advantageous to develop construction of the panels used within the fence that would be lightweight and have the structural strength and rigidity to resist forces from high winds or dirt placed against the fencing structure. It has also been recognized that it would be advantageous to create a means of connecting the panels and the supporting posts that allows for connection with increased angular displacement of the panel. It has also been recognized that it would be advantageous to develop a means of connecting the fencing panels to the supporting posts that allows for increased tolerances in the length between the supporting columns and that can help to mitigate the effects of thermal expansion on the connection of the fencing panel to the post.

According to one aspect of the invention, the fence is constructed from pre-made component pieces such as supporting posts, fencing panels that connect the posts, external molded covers for the supporting posts, decorative capstone pieces for the supporting posts, and components for placing a gate within the fencing structure.

According to one aspect of the invention, the fencing panels have an outer surface made from a polymeric material that may be rotationally molded to simulate the appearance and texture of stone or brick. There is a hollow within the shell created by the molded external surface.

According to one aspect of the invention, two or more U-shaped supporting beams placed longitudinally within the hollow inside the fencing panels are provided that increase the structural strength and rigidity of the panel. The U-shaped beams may increase the ability of the fencing panel to resist forces applied to the panel by wind and allow for the fence to be used as a retaining wall.

According to another aspect of the invention, the U-shaped supporting beams may be surrounded by an injected or a poured polymeric foam or other material that can flow over the beams and fill in the remaining volume within the fencing panel. The foam may provide additional structural support to the fencing panel or improved acoustic properties.

According to another aspect of the invention, the U-shaped supporting beams may have one or more holes in the medial plane of the U-shaped supporting beam to help create a uniform thermal expansion of the foam during temperature change. The U-shaped supporting beam may be comprised of metal or composite material. The thermal expansion rate of the supporting beam is less than the thermal expansion rate of the foam and of the polymer fencing panel. The holes in the center of the supporting beam secure the foam to the beam while allowing the foam and the polymer shell of the fencing panel beyond the vertical centerline to slide or move at a different rate than the supporting beams during thermal expansion or contraction.

According to another aspect of the invention, a reinforcing truss fabricated from a series of disjoint segments of a reinforcing material such as steel wire connected to one another diagonally between their midpoints may serve as a replacement for the U-shaped channels. Of course, one skilled in the art may select any material known to be suitable for creating the truss. The truss may also be molded directly into the outer surface material of the fencing panel, and a reinforcing foam may or may not be used to fill the remaining volume within the fencing panel.

According to another aspect of the invention, the vertical edges of the fencing panels may be constructed with an edge that extends outwards along the lateral planar surface of the fencing panel. This extended edge or “lip” may be used in conjunction with the connecting area of the support posts to secure the panel to the support post during periods of thermal contraction.

According to another aspect of the invention, the connection point between the support post and the fencing panel is formed by flanges and lips on the support post that work in combination with the extended edge on the fencing panels' lateral edges to ensure that the fencing panel remains attached to the support post during thermal contraction while still allowing for tolerances within the connection to allow for thermal expansion. This flexibility in the connection is advantageous in that it allows for increased ease of installation and for placing the fencing panels at an angle relative to the support post. The allowances for thermal expansion and contraction also help to reduce maintenance required of the fence.

According to another aspect of the invention, covers may be installed to surround the support posts that can be molded from a polymeric material like that used to form the fencing panels and can simulate the appearance of the desired fencing material. A cap to go on top of the post may also be installed.

The previously described aspects of the invention have many advantages, including increased ease of installation and repair, reduced weight while retaining sufficient strength to withstand high winds and serve as a partial retaining wall, the ability to undergo thermal expansion or contraction without damage to the fencing components, cost savings, and the ability to select the traditional fencing material or appearance of the fence to be molded during manufacture.

These and other aspects of the present invention are realized in a modular fencing design that can simulate the appearance and texture of stone or other traditional fencing materials as shown and described in the following figures and related description.

### BRIEF DESCRIPTION OF THE DRAWINGS

These and other features, aspects, and advantages of the present invention will become better understood with regard to the following description, appended claims, and accompanying drawings where:

FIG. 1 shows a perspective view of one embodiment of a supporting post structure in accordance with one or more aspects of the present invention.

FIG. 2 shows an elevation view of a fencing panel with the simulated capstones in place along the panel in accordance with one or more aspects of the present invention.

FIG. 3 shows a schematic elevation view of a fencing panel representing an embodiment of the design with two of the U-shaped reinforcing beams in place in accordance with one or more aspects of the present invention.

FIG. 4 shows a schematic elevation view of a fencing panel representing an embodiment of the design featuring a plurality of the U-shaped reinforcing beams in place within the panel in accordance with one or more aspects of the present invention.

FIG. 5 shows a perspective view of the U-shaped reinforcing beams in different dimensions for use as either a top or bottom beam or as an intermediate beam to be used within the fencing panels in accordance with one or more aspects of the present invention.

FIG. 6 shows a vertical cross-sectional view of a fencing panel with the top and bottom U-shaped reinforcing beam positioned within the panel in accordance with one or more aspects of the present invention.

FIG. 7 shows a horizontal cross-sectional view of a fencing panel in accordance with one or more aspects of the present invention.

FIG. 8 shows a plan view of a connection point between a supporting post and two fencing panels in accordance with one or more aspects of the present invention.

FIG. 9 shows a plan view of a connection point between a supporting post and two fencing panels with an angular displacement of up to 30° from straight in accordance with one or more aspects of the present invention.

FIG. 10 shows a horizontal cross-sectional view of a fencing panel with a representation of a U-shaped channel in place in accordance with one or more aspects of the present invention.

FIG. 11 shows a plan view the supporting post column covers as fitted with a supporting post in accordance with one or more aspects of the present invention.

FIG. 12 shows an axonometric view of a supporting post column cover in accordance with one or more aspects of the present invention.

FIG. 13 shows a plan view of the connection point between a supporting post with two fencing panels with the supporting post column covers in place in accordance with one or more aspects of the present invention.

FIG. 14 shows a profile view of two differently sized gates as can be connected to a supporting post in accordance with one or more aspects of the present invention.

FIG. 15 shows cross sectional views of support post caps in accordance with one or more aspects of the present invention.

FIG. 16 shows a perspective view of an embodiment of a support post cap in accordance with one or more aspects of the invention.

FIG. 17 shows an elevation view of a section of the 8′×6′ fence as installed comprised of two supporting posts and a fencing panel in accordance with one or more aspects of the present invention.

FIG. 18 shows perspective views of two embodiments of a supporting truss alternative to the U-shaped channels where one embodiment has the peripheral support pieces connected and the other with them disjointed.

FIG. 19 shows a horizontal cross-sectional view of a fencing panel with a representation of a disjointed supporting truss in place in accordance with one or more aspects of the invention.

FIG. 20 shows a plan view and a perspective view of a fencing panel in an embodiment with a notch in the top of the capstone to allow for the support post cap to fit within it while it the components are used in conjunction with a support post.

It will be appreciated that the drawings are illustrative and not limiting of the scope of the invention which is defined by the appended claims. The embodiments shown accomplish various aspects and objects of the invention. It is appreciated that it is not possible to clearly show each element and aspect of the invention in a single figure, and as such, multiple figures are presented to separately illustrate the various details of the invention in greater clarity. Similarly, not every embodiment need accomplish all advantages of the present invention.

### DETAILED DESCRIPTION

The invention and accompanying drawings will now be discussed in reference to the numerals provided therein so as to enable one skilled in the art to practice the present invention. The drawings and descriptions are exemplary of various aspects of the invention and are not intended to narrow the scope of the appended claims.

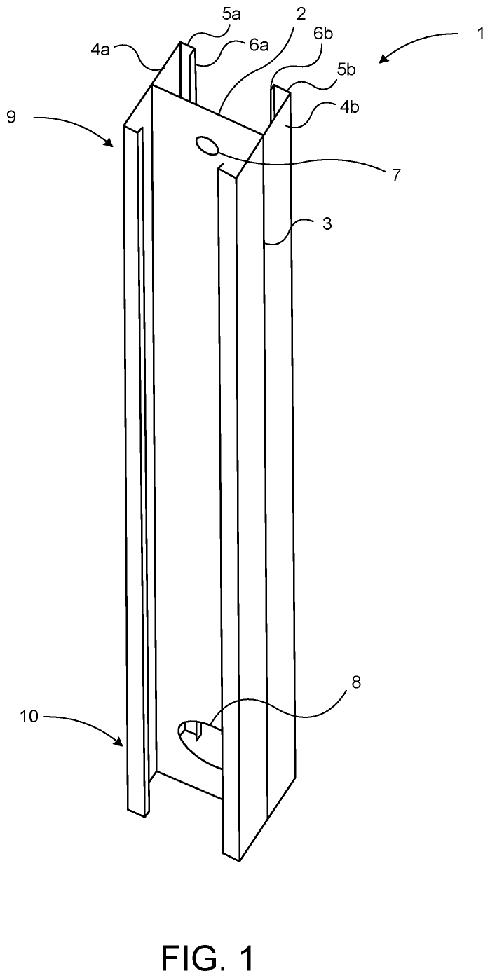

Referring now to FIG. 1. a perspective view of a supporting post 1 for a use in conjunction with a fencing panel in accordance with one or more aspects of the present invention is shown. As seen in FIG. 1, the supporting beam may be constructed in an “H” shape. In this embodiment, the supporting post 1 includes a central body 2 with one or more extensions 4. Each extension 4 may include a flange 5 disposed opposite the central body 2 on the extension 4. In the illustrated embodiment, each flange 5 includes an inward leading geometry with an additional structure in the form of a lip 6. In the illustrated embodiment, each lip is directed inward towards the central body 2 of the supporting post 1.

In one embodiment, the “H” shape of the supporting post 1 is formed by affixing two U-shaped beams together at a common center interface 3. The supporting post 1 may be constructed from any material with the structural characteristics known by those skilled in the art to be suitable for fencing. For example, the material may include a roll formed steel affixed together through a joining process, such as clenching process. In some embodiments, the joining process may be selected based on material, strength, and cost considerations.

In some examples, the supporting post 1 may have outer dimensions of 4.5″×5″ with the flange 5 on each extension 4 measuring 0.75″ long and leading to a 0.30″ lip 6 where both the flange 5 and the lip 6 may be at 90° angle from the body of the “H”. Other relative angles are contemplated. The thickness of the material may be adjusted by one skilled in the art to meet the necessary strength requirements based on the material chosen. In some embodiments, at least a portion of the support post 1 may have a thickness of 0.062″ and may be constructed of thick roll-formed steel.

In other examples, the supporting post 1 may have relatively larger outer dimensions of 6.5″×7″ where the flanges 4a, 4b have a length of 1.5″ and the lips 6a, 6b are 0.50″ in length. Changes in the length and other geometries may have corresponding changes in the thickness of the material which may be adjusted by one skilled in the art to meet the strength requirements needed based on the chosen material.

The length of the post may be varied according to the desired usage. The supporting post 1 may be erected by placing one end 10 of the supporting post 1 into a hole of suitable depth within the ground upon which the fence is to be constructed and then securing the supporting post 1 within the hole with a supporting material such as concrete.

The central body interface 2 of the support post 1 may include a hole or cutout near one end of the post 10 to serve as an interlocking hole 8 for supporting material to fill and set within to add additional structural stability to the supporting post 1. In some examples, the interlocking hole 8 may include a 3″ diameter. The diameter of the interlocking hole 8 may be adjusted by one skilled in the art depending on the supporting material selected or other considerations. In another embodiment of the invention, the supporting post 1 may omit the interlocking hole 8.

FIG. 1 also shows an embodiment of the invention with a hook hole 7 on the opposite end 9 of the supporting post 1. The hook hole 7 may be for use in conjunction with a painting hook, as it may be advantageous, during the manufacturing process, shipping, installation, replacement, or repair, to have a point on the supporting post 1 where it can be suspended from, supported, or strung together with a plurality of posts. Some embodiments of the supporting post 1 may omit the hook hole 7.

Some examples of the supporting post 1 may be sized and otherwise configured to accommodate a range of panel heights, thicknesses, and the like. In some embodiments, one or more geometries of the supporting post 1 may be increased, reduced, or otherwise changed while other geometries of the supporting post 1 remain unchanged. For example, the outer dimensions of the supporting post 1 as well as the lengths of the flanges 5 and lips 6 may be increased while the hook hole 7 and the interlocking hole 8 may remain unchanged. Other combinations or changes are also contemplated.

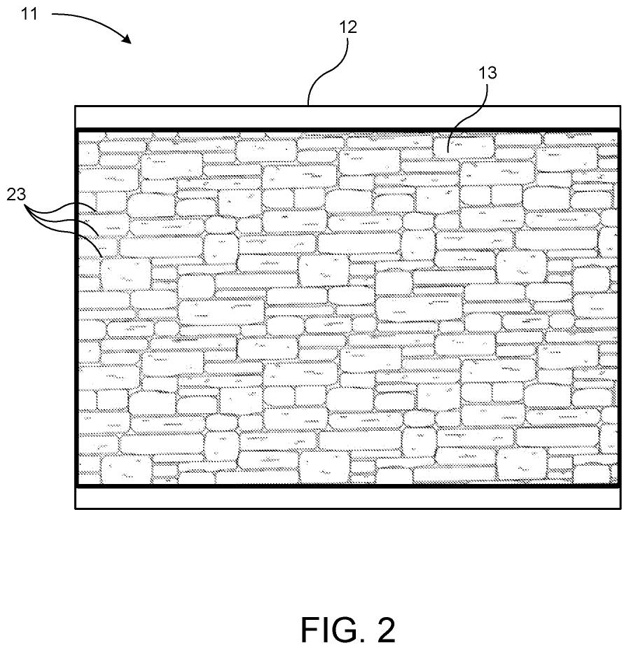

Referring to FIG. 2, a side view of a fencing panel 11 is shown. In the illustrated embodiment, the fencing panel 11 includes a panel face 13 to simulate the appearance of stone or other traditional fencing materials. The panel face 13 of the fencing panel 11 may be constructed from a material with sufficient durability which can be molded or otherwise shaped to simulate a stone, wood, brick, block, or other form. In some embodiments, at least a portion of the fencing panel 11 may be rotationally molded. For example, one or more components of the fencing panel 11 may include a polymeric material such as polyethylene. In some examples, rotational molding offers advantages in cost and time of production. Other manufacturing processes may also be used to form a component of the fencing panel 11, such as the panel face 13.

The panel face 13 may include textures, patterns, or other variations in the panel face 13. In the illustrated embodiment, grooves are molded or shaped into the outer panel face 13 of the fencing panel 11 to simulate the appearance of stone. The grooves 23 or similar features may also be included to simulate other materials or aesthetic effects. As shown in FIG. 2, the panel face 13 may be formed into an embodiment that simulates the appearance of stone laid with the grooves 23 simulating grout lines, stone edges, or the like. Additionally, the panel face 13 may include a surface texture, coloration, or the like to further improve the simulation. One or more of these characteristics may be formed in one or more stages of manufacture, installation, or after installation. Features of the panel face 13 may be molded, machined, or otherwise formed in the panel face 13 by someone skilled in the art to simulate other materials. The illustrated embodiment also includes a capstone 12. Capstones 12 may be molded or otherwise added into the fencing panel 11 to further alter the appearance of the fencing panel 11 or to offer other structural or aesthetic features. For example, the capstone 12 may be formed or added to the fencing panel 11 to improve a rigidity, flexibility, interface with another component (such as another fencing panel 11 in a stacked arrangement), or the like. The capstone 12 may be applied to one edge of the fencing panel 11 or to multiple edges of the fencing panel 11.

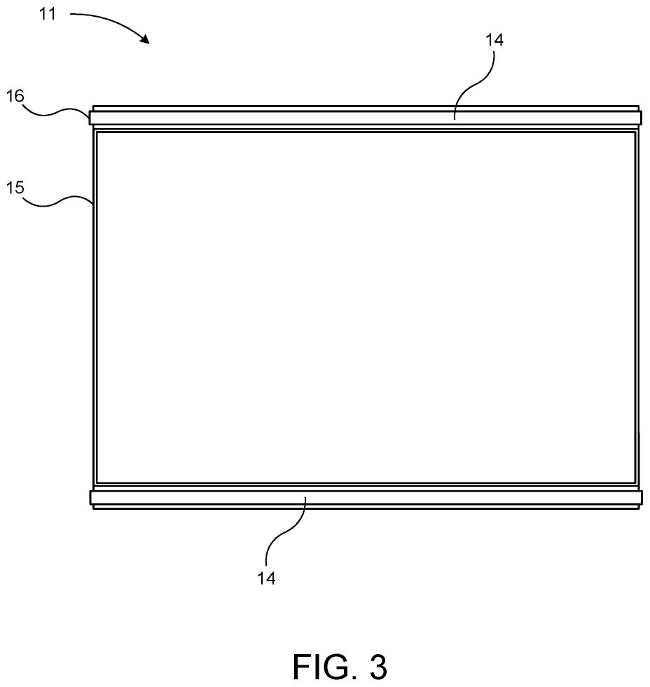

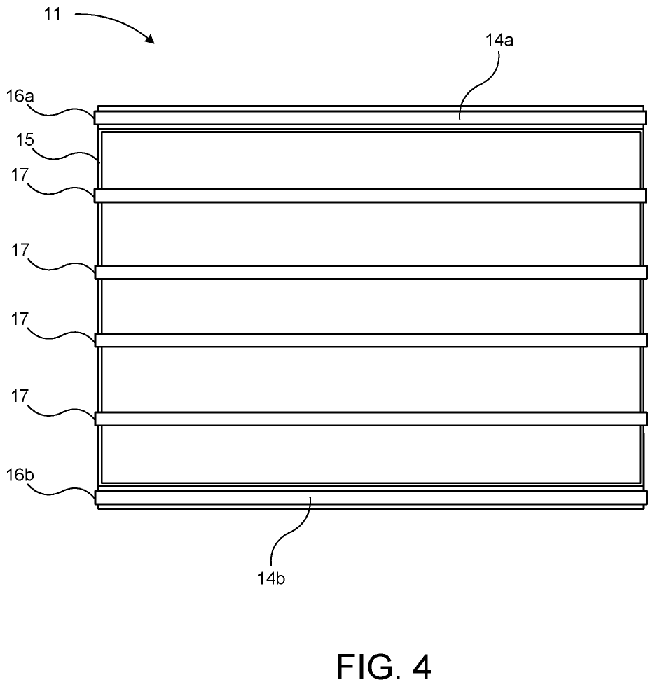

Referring now to FIGS. 3 and 4, schematic drawings of fencing panels 11 are shown. In FIG. 3, a reinforcing channel 14 is integrated into the fencing panel 11 at the top and bottom of the panel 11. The reinforcing channels 14 may include a protrusion 16 which extends beyond a lateral edge 15 of the panel 11. In some embodiments, the protrusion 16 allows for the surface material 13 to undergo thermal expansion and contraction around the reinforcing channels 14 without trapping the channels 14 within the outer surface material 13. In some embodiments, this reduces internal stresses in the panel 11 which may help to avoid warping or other damage to the panel face 13 or other portion of the fencing panel 11. In some embodiments, the reinforcing channels 14 are coupled to the fencing panel 11 during manufacturing. For example, the reinforcing channels 14 may be integrated into the fencing panel 11 during a rotational molding process in which the panel face 13 is formed. This may offer cost savings and can be relatively quickly manufactured. Other methods of installing the reinforcing channels relative to the fencing panel 11 are contemplated.

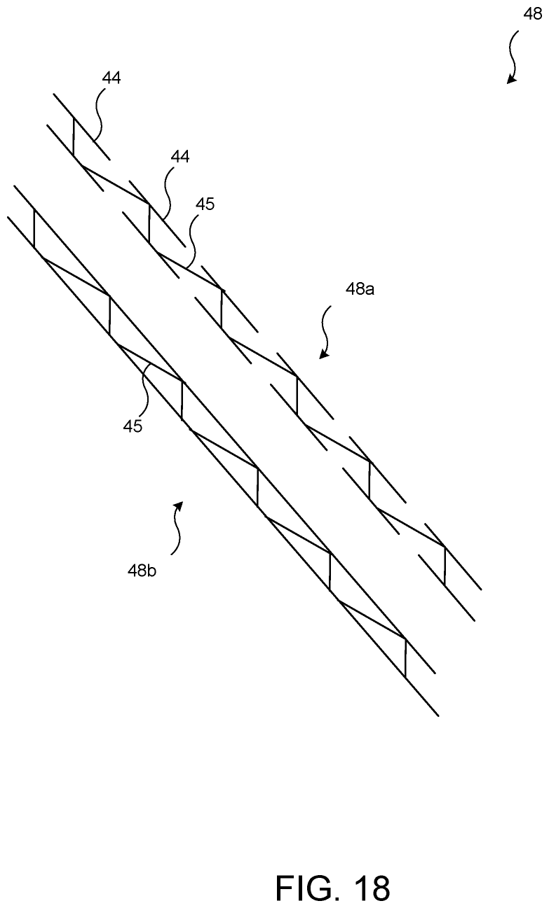

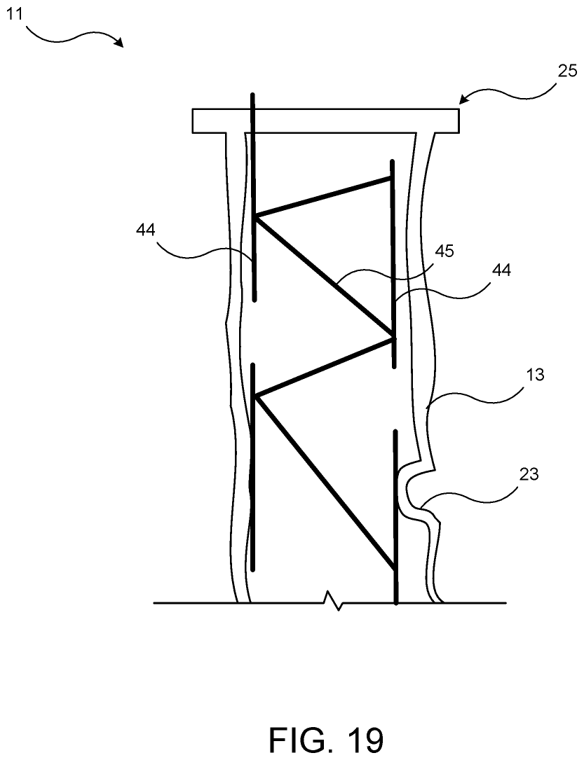

In some embodiments, one or more intermediate reinforcing channels 17 may be added between the reinforcing channels 14 disposed at the edges of the fencing panel 11. The illustrated embodiment of FIG. 4 shows a plurality of intermediate reinforcing channels 17 coupled to the fencing panel 11. In some embodiments, two reinforcing channels 14a and 14b and four intermediate reinforcing channels 17. While the illustrated embodiment shows a total number of channels 14 and 17 is six. Other embodiments may incorporate fewer or more of each of the channels 14 and 17. Each of the reinforcing channels 14 and 17 maintain the protrusions 16 when a greater number of reinforcing channels 14 and 17 are used. Additional reinforcing channels 14 and 17 may serve to add strength to the fencing panel 11 to increase the amount of force the fencing panel 11 can withstand without adding significant weight. Each of the reinforcing channels 14 and 17 may have a u-shaped geometry. Alternatively, the reinforcing channels 14 and 17 may have a Z-shaped geometry, as shown and described below with reference to FIGS. 18 and 19. Other shapes and geometries may also be used for the reinforcing channels 14 and 17. Different geometries may be used together or exclusively of one another. For example, the reinforcing channels 14 may be u-shaped while the intermediate reinforcing channels 17 may be z-shaped.

In some embodiments, incorporation of the reinforcing channels 14 and 17 allows the fence panel 11 to resist forces from winds and to serve other structural purposes, such as serving as a partial retaining wall. In some embodiments, a plurality of channels 14 and 17 and could be used as a partial retaining wall. For example, embodiments of the fencing panels 11 may be used for heights of two feet, three feet, four feet, or other heights. In some embodiments, the number of additional reinforcing U-shaped channels 14 and 17 added to the panel 11 corresponds to the specific needs for a particular usage.

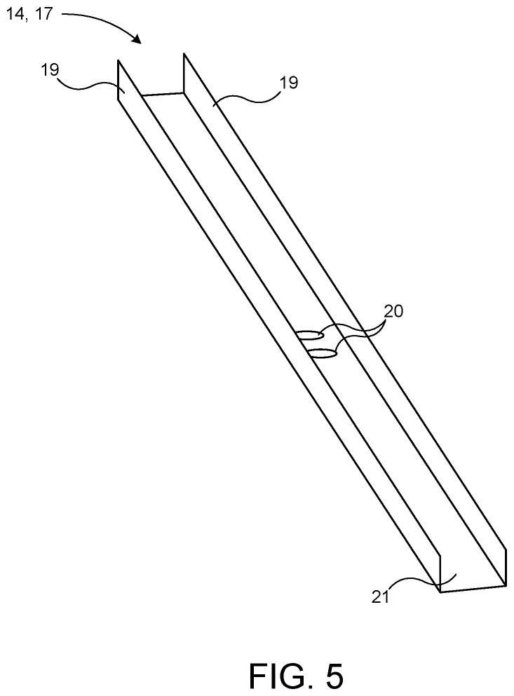

Referring now to FIG. 5, a perspective view of an embodiment of the reinforcement channels 14 for use on the top and bottom of a fencing panel 11 is shown alongside an embodiment of the intermediate reinforcement channels 17 to be used between the top and bottom of the fencing panel 11. The illustrated embodiments of the U-shaped channels have a central structure 21 between two extensions 19. In some examples, outer dimensions of 2.5″×1.5″ and 2.0″×1.5″ may be used. Other dimensions and relative sizes may also be used. In some embodiments, the dimensions may be selected by someone skilled in the art to meet the size requirements for a specific use. The reinforcing channels 14 and 17 may be constructed from a range of materials includes plastics, composites, metals, or other natural or synthetic materials or combination of materials. In some examples, the reinforcing channels 14 and 17 are manufactured from roll-formed steel.

In the illustrated embodiment, one or more holes 20 may be formed within the central structure 21 of the reinforcing channel 14 and 17. The one or more holes 20 may allow for a supportive filling to flow around the reinforcing channels 14 and 17 and to help anchor the material and promote more uniform thermal expansion across the length of the fencing panel 11. In some embodiments, the supportive filling is a poured polyethylene foam. Other materials or combination of materials may be selected.

While the illustrated embodiment includes a pair of holes 20 formed in a middle of the reinforcing channels 14 and 17, fewer or more holes 20 may be formed at other locations and at other relative positions along the reinforcing channels 14 and 17. In other embodiments, the holes 20 may be omitted.

Referring now to FIGS. 18 and 19, a truss structure 48 is shown. In some embodiments, the truss structure 48 is an alternative reinforcing structure to the U-shaped reinforcing channels 14 and 17 of FIG. 5. FIG. 18 shows perspective views of a disjoint truss 48a and a continuous truss 48b. The disjoint truss 48a is a variant of the truss support structure 48 in which a plurality of disjointed pieces of a reinforcing steel wire 44 are connected at angles with a central wire 45. The continuous truss 48b is an embodiment in which the peripheral support structure 46 is constructed from a continuous length of wire that corresponds to, and is secured along, a length of the fencing panel 11. The truss support structures 48, whether comprising continuous 46 or disjointed outer wires 44, may serve to allow for thermal expansion within the fencing panel 11 without causing warping or damage to the fencing panel 11 as a result of the strain from the materials in the fencing panel 11 expanding at different rates. In some examples, the truss support structure 48 incorporates a ⅛″ thick steel wire, but any other suitable material known by one skilled in the art may be used. The disjoint truss 45 may serve to allow for thermal expansion within the fencing panel 11 without causing warping or damage to the fencing panel 11 as a result of the strain from the materials in the fencing panel 11 expanding at different rates.

As is shown in FIG. 19 the truss structures 48 can be placed within the fencing panel 11 in the same or similar locations as those used for the U-shaped reinforcing channels 14 and 17. The truss structure 48 can be formed into an outer surface of the fencing panel 11 when it is rotationally molded. In other embodiments, the truss structure 48 can be formed into the panel face 13. In some embodiments, the disjointed truss 48a is shown with the segments of the reinforcing steel wire 44 connected via the central support 45. The truss structure 48 may extend beyond the lateral edge of the fencing panel 11 or it may be contained entirely within it. The fencing panel 11 using the disjoint truss 48a may include a supportive material such as foam. In another embodiment, the fencing panel 11 using the disjoint truss 48a may be constructed without a supportive material such as foam.

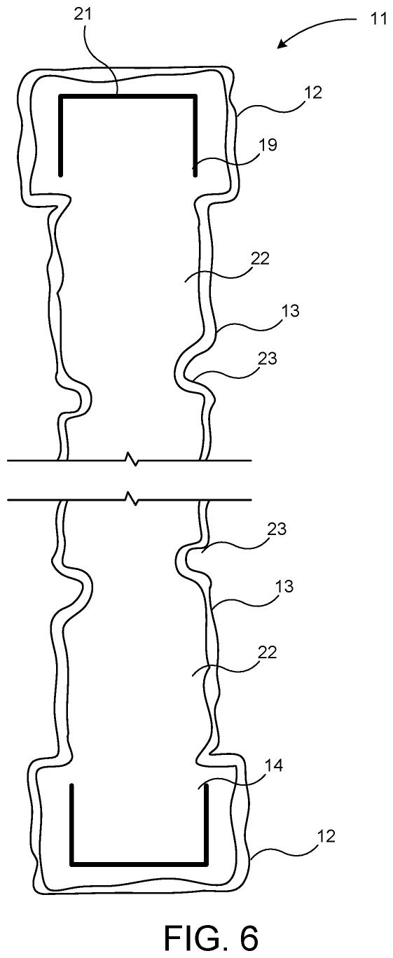

Referring to FIG. 6, a truncated vertical cross-sectional view of a fencing panel 11 is shown. The panel face 13 is shown with the grooves 23 displayed. The interior of the fencing panel 11 is shown filled in with a supporting material 22. The supporting material 22 may fully or partial surround the reinforcing channels 14 disposed within the fencing panel 11.

In the illustrated embodiment, the capstone 12 encapsulates the reinforcing channels 14. In other embodiment, the reinforcing channels 14 are sized to contact an outer threshold of the face panel 13 along an interior surface of the capstone 12. In some embodiments, this relative position of the reinforcing channels 14 and the capstone 12 includes the use of a supportive filling material. In other embodiments, the supportive filling material may be omitted. In another embodiment, one or more truss structures 48 may be used in place of the reinforcing channels 14 and 17.

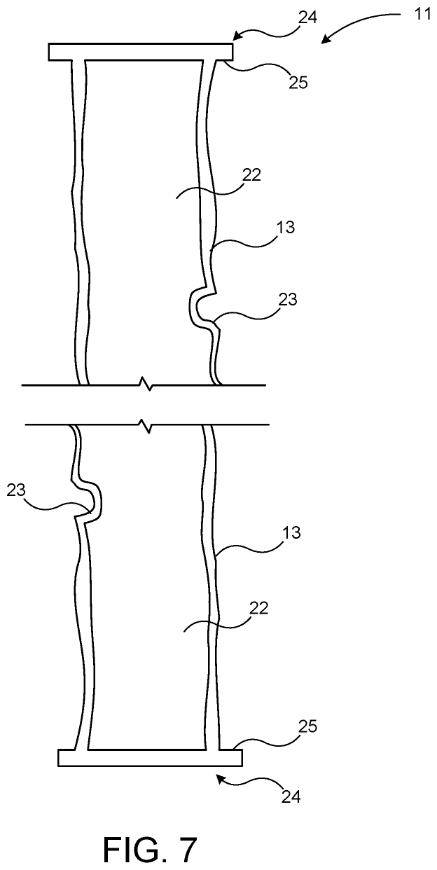

Referring now to FIG. 7, a truncated horizontal cross-sectional view of a fencing panel 11 is shown. In the illustrated embodiment, the panel face 13 is extended along the lateral sides 24 to form a flange 25 which can serve to secure the fencing panel 11 connection to the supporting post 1 during times of thermal contraction. In some examples, the flanges 25 may be 0.5″ in length. Other flange dimensions may also be used. The flanges 25 may be extended along some or all of the length of the lateral side 24 of the fencing panel 11. A single flange 25 or a plurality of flanges 25 may be used. The number and placement of the flanges 25 may be more or less or different from the illustrated embodiment. The flange 25 may be operable to reduce disconnection of the fencing panel 11 from the support post 1 during thermal contraction and/or expansion.

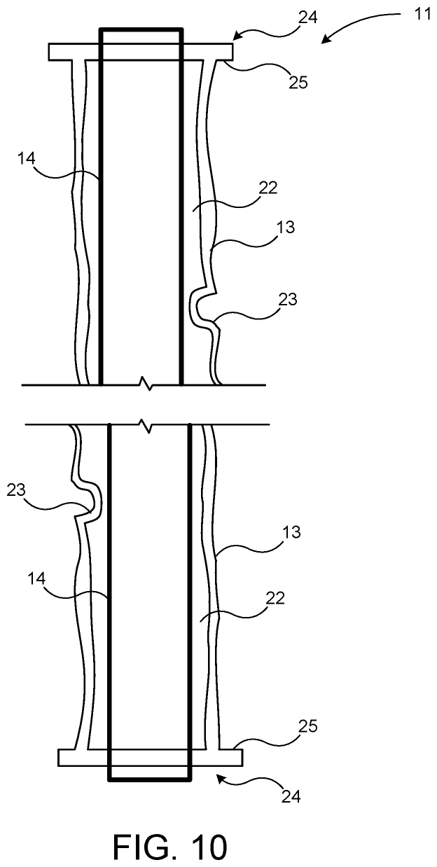

In FIG. 10 a horizontal cross-sectional view of an alternative embodiment is shown. In the illustrated embodiment, the reinforcing channel 14 is disposed relative to the outer surface of the panel face 13. In the illustrated embodiment, the reinforcing channel 14 extends beyond the lateral edge of the panel face 13. In other embodiments, the reinforcing channel 14 does not extend beyond the lateral edge of the panel face 13.

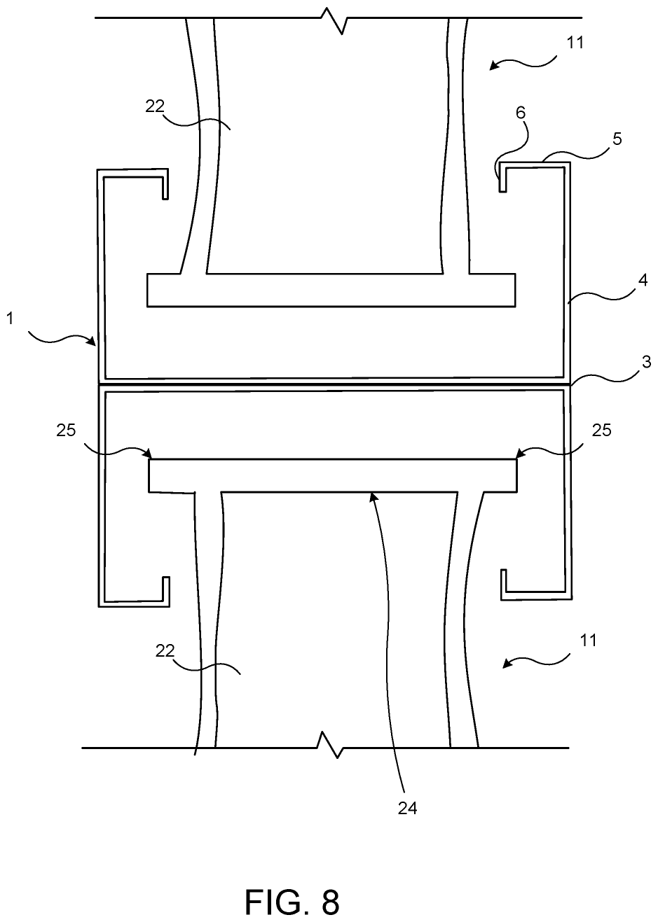

A cross-sectional view of the connection between two fencing panels 11 and a supporting post 1 is shown in FIG. 8. The lateral edge 24 of the fencing panel 11 is fit between the extensions 4 of the supporting post 1 with the flanges 25 of the fencing panel 11 extending beyond the flange 5 and lip 6 of the supporting post 1. The dimensions of the flanges 25 on the fencing panel 11 may be different to ensure that they will not fit between the gap in the lips 6 on the supporting post 1 so that the fencing panel 11 remains connected to the supporting post 1 during thermal contraction/expansion. The relative arrangement and geometric interaction of the supporting post 1 and the fencing panel 11 allows for increased tolerances between the supporting post 1 and the fencing panel 11. In some examples, this increase in tolerance simplifies installation and allows for thermal expansion while also ensuring that the fencing panel 11 will remain secured during thermal contraction/expansion.

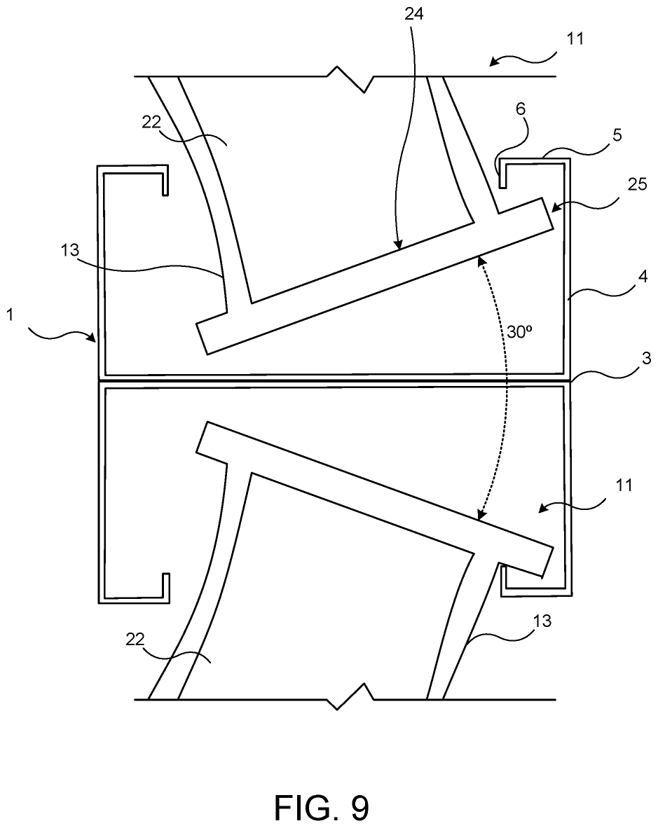

As can be seen in FIG. 9, the fencing panel 11 may be placed at an angle within the supporting post 1. In some embodiments, the relative angle of the fencing panels 11 is an approximate angle of 30°. The maximum angular variation may be varied according to the dimensions of the component pieces chosen by someone skilled in the art.

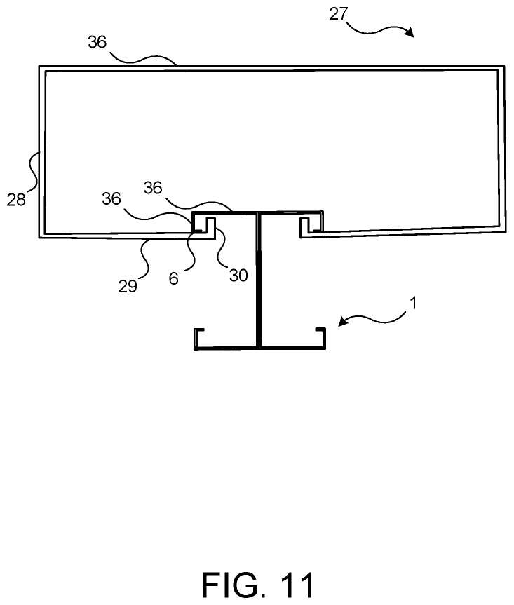

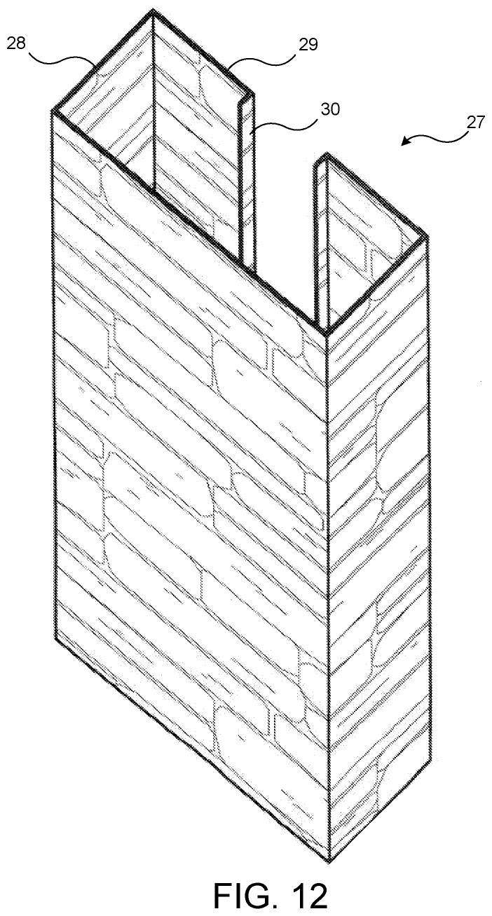

Referring now to FIGS. 11 and 12, a column cover 27 may be placed over the support post and used in conjunction with the fencing panels 11. Shown in FIG. 11 is a cross-sectional view of the column cover 27. In the illustrated embodiment, the column cover 27 is shaped like one half of the supporting post 1. The shape of the column cover 27 allows for the column cover 27 to attach to the supporting post 1. Column cover flanges 30 of the column cover 27 have a geometry to correspond to, and fit along, a lip 6 of the supporting post 1. In some embodiments, the column cover flanges 30 serve to improve security of the column cover 27 in place on the supporting post 1.

The column cover 27 may be manufactured from any suitable material chosen by someone skilled in the art. In some embodiments, the column cover 27 is constructed with rotationally molded polyethylene material. The material of the column cover 27 may be similar to or different from material used in the manufacture of the panel face 13. In some embodiments, the choice of similar materials provide cost advantages and also provides all of the outwardly visible component pieces with the same coefficients of thermal expansion and aesthetic characteristics. The column covers 27 may be made with a similar or different surface texture than the fencing panel 11. Shown in FIG. 12 is perspective view of one embodiment of the column cover 27. In the illustrated embodiment, the column cover 27 includes a surface pattern or other aesthetic characteristic similar to that of the fencing panel 11 in FIG. 2.

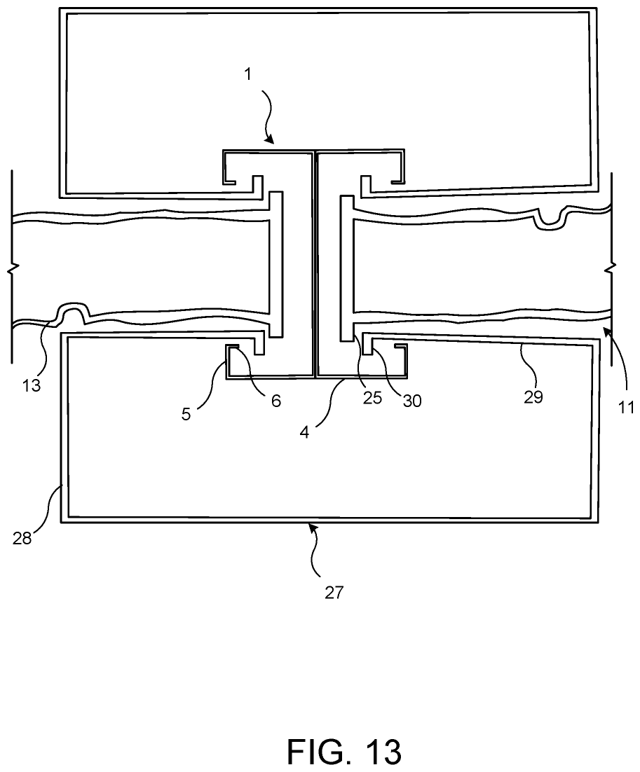

Shown in FIG. 13 is a cross-sectional view of the supporting post 1 and fencing panel 11 coupled, with column covers 27 in place also on the supporting post 1. In some embodiments, a sufficient distance is included between the components to allow for thermal expansion while also ensuring that the fencing panel flanges 25 will be retained by the column cover lip 30 and the support post lip 6 during thermal contraction.

The column covers 27 may be put in place around the support post 1 before or after the installation of the fencing panels 11 in accordance with the arrangement shown in FIG. 13. This is advantageous because it simplifies the installation and allows for a damaged component to be replaced without having to remove additional components from the existing assembly.

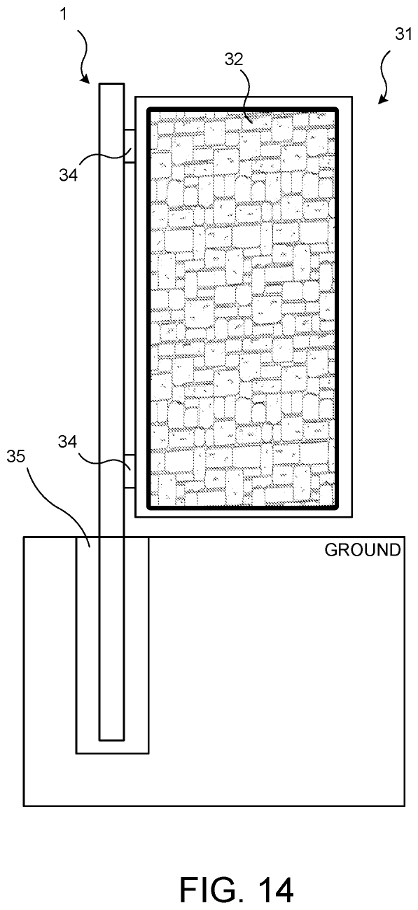

Referring now to FIG. 14, a profile view of a gate 31 that can be affixed to the support post 1 is shown. In the illustrated embodiment, the supporting post 1 is set within a foundation 35 to create an entrance through the fence. The foundation 35 may be made from concrete or any other material known to someone skilled in the art to be suitable for creating a foundation structure for fencing. The gate 31 may be affixed to the supporting post 1 via a hinge 34 or a plurality of hinges 34 as shown by the embodiment in FIG. 14. Other means, such of attaching the gate 31 to the supporting post may also be used in place of, or in conjunction with, the hinges 34.

The surface 32 of the gate 31 may be constructed in a similar fashion to the face panel 13 to maintain a consistent aesthetic appearance. In other embodiments, a different material or appearance may be incorporated. In some embodiments, the gate 31 may be constructed using the same polyethylene materials and rotational molding process as was used to manufacture the fencing panels 11. In some embodiments, reinforcing steel tubes 33 may be molded into the gate 31 to increase the strength of the gate 31. Other reinforcing structures may also be incorporated.

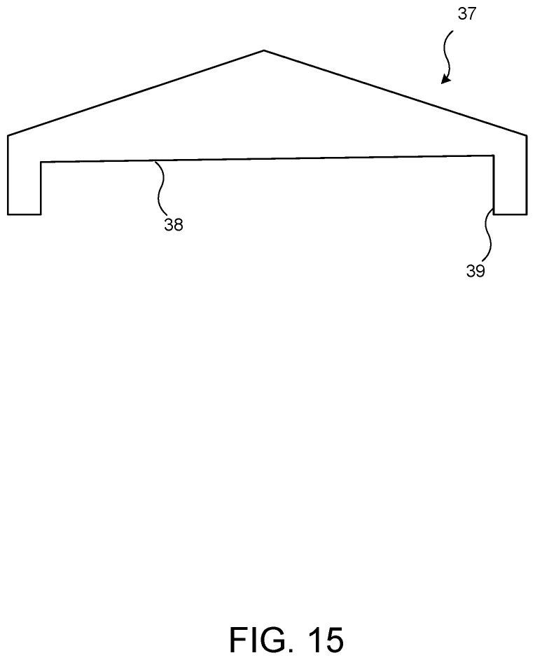

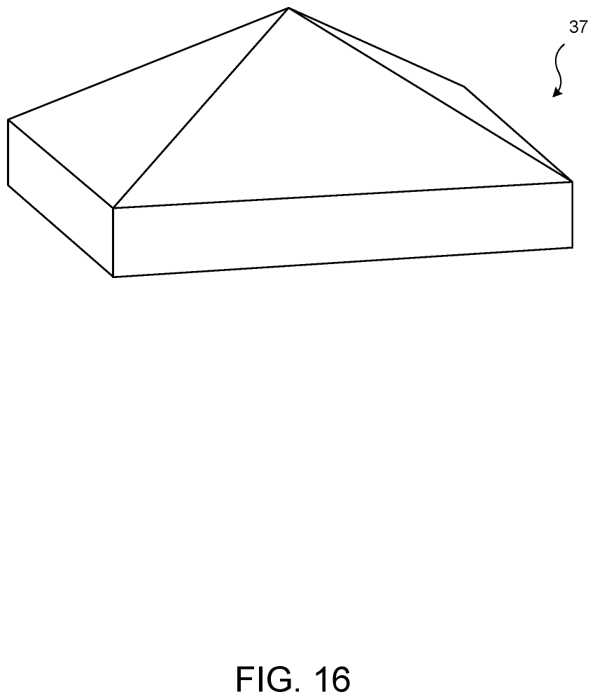

Referring to FIGS. 15 and 16 a post cap 37 may be fitted on top of the supporting posts 1. In some embodiments, the post cap 37 may be sized to further extend over a portion of the column covers 27. A length of the central interior plate 38 of the post cap 37 may depend on a size of the column cover 27 that the post cap 37 must fit over. The exact dimensions of the post cap 37 may be selected by someone skilled in the art to ensure a secure fit over the column covers 27 as the sizes selected may vary. In some embodiments, the post cap 37 may be manufactured from the same material as the column cover 27 to minimalize issues resulting from these components having different coefficients of thermal expansion. Other materials and manufacturing may be use as corresponds to a specific use.

A perspective view of a post cap 37 is shown in FIG. 16. A pyramidal design is shown, but one skilled in the art could vary the shape of the post cap 37 to any suitable shape which may include or omit any ornamental or aesthetic characteristics.

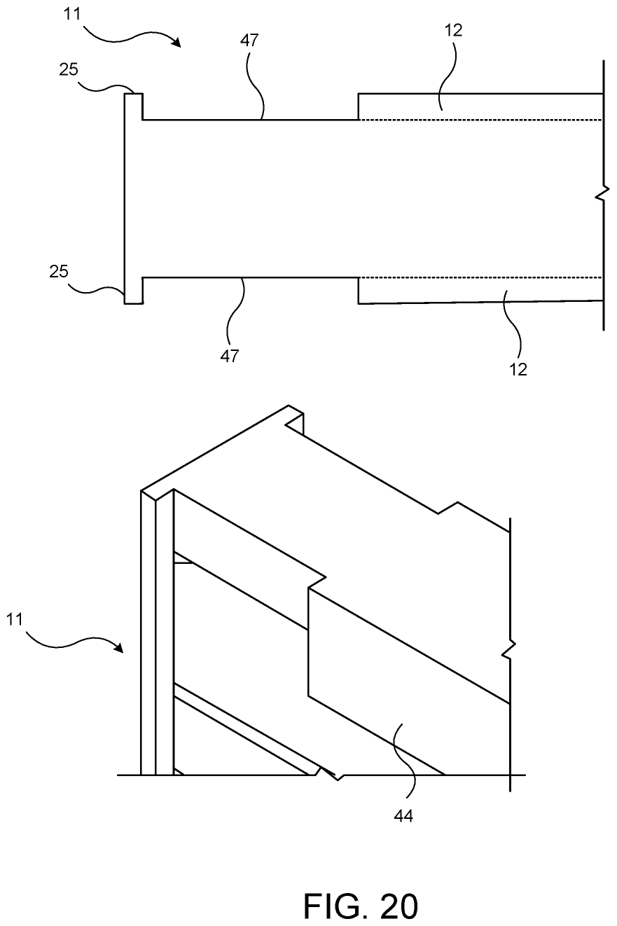

Referring now to FIG. 20, cross-sectional and perspective views of a fencing panel 11 are shown. The fencing panel 11 may include a notch 47 formed into the fencing panel 11 to form a space between flange 25 of the fencing panel 11 and the capstone 12 to accommodate or secure a post cap 37 onto a supporting post 11.

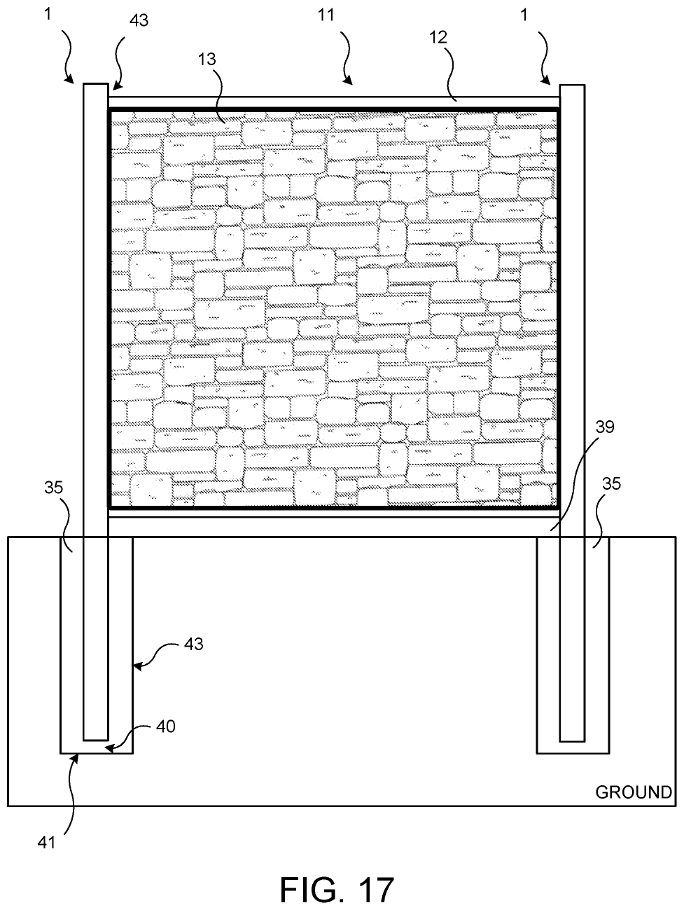

Referring now to FIG. 17, a profile view is shown of one embodiment of two support posts 1 and a fencing panel 11 in an assembly. In the illustrated embodiment, the supporting posts 1 are embedded in a foundational material 35. The depth of the foundational material 42 and the diameter of the material 41 may be any suitable depth and diameter as chosen by someone skilled in the art. The depth 40 to which the foundational material extends beyond the supporting post 1 may be chosen by someone skilled in the art as any distance suitable for maintaining proper structural support. For example, the depth 40 may be 2″ below the supporting post 1.

In the illustrated embodiment, the supporting post 1 extends beyond an upper limit of the fencing panel 11. The distance 43 between the top of the fencing panel 11 and the top of the supporting post 43 may be chosen by someone skilled in the art to be any distance that suits the aesthetic needs of the fence and allows for the post cap 37 to be installed with enough distance between the components to allow for thermal expansion. In some embodiments, this distance 43 will depend on the sizes of the supporting post 1 and the fencing panel 11 selected. The clearance 39 between the ground level and the bottom of the fencing panel 11 may be selected by someone skilled in the art as any distance suitable to allow for thermal expansion based on the sizes of the components and the materials from which the components were manufactured.

There is thus disclosed an improved fence that simulates the appearance of stone or other traditional fencing materials. It will be appreciated that numerous changes may be made to the present invention without departing from the scope of the claims.

What is claimed is:

1. A fence system comprising:
a first fencing panel having a first lip formed on a first side of an edge of the first fencing panel and a second lip disposed on a second side of the edge of the fencing panel, the second side being opposite from the first side; and
a supporting post having an H-shaped geometry to receive the first lip and the second lip of the first fencing panel to secure the first fencing panel relative to the supporting post.

2. The fence system of claim 1, further comprising a column cover disposed on the supporting post.

3. The fence system of claim 1, wherein the supporting post comprises a roll-formed steel.

4. The fence system of claim 1, wherein the supporting post is configured to receive a second fencing panel opposite the first fencing panel.

5. The fence system of claim 4, wherein the supporting post is configured to allow the first fencing panel and the second fencing panel to be secured in the supporting post and allow the first fencing panel and the second fencing panel to be pivoted about the supporting post to be oriented at a non-zero angle relative to one another.

6. The fence system of claim 1, wherein the first fencing panel further comprises a face panel configured to simulate a natural stone.

7. The fence system of claim 1, wherein the first fencing panel further comprises at least one reinforcing channel.

8. The fence system of claim 7, wherein the at least one reinforcing channel comprises one or more intermediate reinforcing channels disposed within the first fencing panel.

9. The fence system of claim 7, where in the at least one reinforcing channel has a U-shaped geometry.

10. The fence system of claim 7, where in the at least one reinforcing channel is a truss structure.

11. The fence system of claim 10, wherein the truss structure is a disjoint truss with a plurality of disjointed pieces of a reinforcing wire connected at angles to a central wire.

12. The fence system of claim 10, wherein the truss structure is a continuous truss with a continuous reinforcing wire along a length of the first fencing panel.

13. The fence system of claim 1, wherein the first fencing panel further comprises a supportive filling material.

14. The fence system of claim 1, further comprising a column cover to engage with the supporting post to cover a side of the supporting post.

15. A method comprising:
rotationally molding a first fencing panel, the first fencing panel having a first lip formed on a first side of an edge of the first fencing panel and a second lip disposed on a second side of the edge of the fencing panel, the second side being opposite from the first side;
roll-forming a steel supporting post to have an H-shaped geometry sized to receive the first lip and the second lip of the first fencing panel to secure the first fencing panel relative to the supporting post.

16. The method of claim 15, further comprising disposing a reinforcing channel within the first fencing panel.

17. The method of claim 16, wherein the reinforcing channel is disposed within the first fencing panel during rotationally molding the first fencing panel.

18. The method of claim 15, wherein rotationally molding the first fence panel comprises forming a panel face in the first fencing panel to simulate a fencing material.

19. The method of claim 15, further comprising disposing a supportive fill material within the first fencing panel.

20. The method of claim 15, further comprising forming a column cover sized to engage with the supporting post to cover a side of the supporting post.
